(19) United States
(12) Patent Application Publication
(10) Pub. No.: US 2025/0330074 A1
(43) Pub. Date: Oct. 23, 2025

(54) VARIABLE AXIAL FLUX MOTOR

(71) Applicant: Jacobi Motors LLC, Missouri City, TX (US)

(72) Inventor: Mohammadreza Barzegaranbaboli, Missouri City, TX (US)

(73) Assignee: Jacobi Motors LLC, Missouri City, TX (US)

(21) Appl. No.: 19/257,112

(22) Filed: Jul. 1, 2025

Related U.S. Application Data
(63) Continuation of application No. 18/157,482, filed on Jan. 20, 2023.
(60) Provisional application No. 63/301,812, filed on Jan. 21, 2022.

(51) Int. Cl. H02K 21/02; H02K 21/24

(52) U.S. Cl. CPC H02K 21/028; H02K 21/24

(57) ABSTRACT

A variable axial flux motor (VAFL) includes: a stator; and a first rotor part. The stator is disposed next to the first rotor part, along a rotational axis of the VAFL. A pole of the first rotor part includes: a first hard magnet; a first soft magnet; and a first ferrous part.

### CROSS-REFERENCE TO RELATED APPLICATIONS

The present application is a continuation of U.S. patent application Ser. No. 18/157,482, filed Jan. 20, 2023, which claims the benefit of U.S. Provisional Patent Application Ser. No. 63/301,812 filed Jan. 21, 2022, all of which are included herein at least by reference.

### BACKGROUND

Synchronous electric motors with permanent magnets such as variable-flux memory motors have a wide range of applications in industrial, commercial, and residential, applications, such as fans, pumps, compressors, elevators, and refrigerators, industrial machinery, and electric motor vehicles because of their high efficiencies. Also, because of using permanent magnets instead of windings in the rotors of the synchronous electric motors, there is no need for a rotor cooling. These advantages along with others (e.g., being brushless) make the synchronous electric motors popular where high torque, high efficiency, or low maintenance for electric motors is needed.

### SUMMARY

In one aspect, embodiments of the invention relate to a variable axial flux motor (VAFL). The VAFL includes a stator; and a first rotor part. The stator is disposed next to the first rotor part, along a rotational axis of the VAFL. A pole of the first rotor part includes a first hard magnet; a first soft magnet; and a first ferrous part.

Other aspects of the invention will be apparent from the following description and the appended claims.

### BRIEF DESCRIPTION OF DRAWINGS

FIG. 1A shows cross-sectional views and an exploded view of an axial flux motor.

FIG. 1B shows cross-sectional views of an axial flux motor and of a radial flux motor.

FIG. 1C shows illustrations of an axial flux motor and of a radial flux motor.

FIG. 2 shows a radial variable flux memory motor (radial VFMM).

FIG. 3A shows different views of a variable axial flux motor (VAFL), in accordance with one or more embodiments of the invention.

FIG. 3B shows magnetic field density of the VAFL shown in FIG. 3A, in accordance with one or more embodiments of the invention.

FIG. 4 shows torque and voltage diagrams of a VAFL, in accordance with one or more embodiments of the invention.

FIG. 5A shows direct access and quadrature axis pulsations (Id and Iq, respectively) of a VAFL in magnetization and running periods, in accordance with one or more embodiments of the invention.

FIG. 5B shows currents in stator windings of the VAFL during the magnetization and running periods shown in FIG. 5A, in accordance with one or more embodiments of the invention.

FIG. 5C shows the torque of the VAFL during the magnetization and running periods shown in FIGS. 5A and 5B, in accordance with one or more embodiments of the invention.

FIG. 6 illustrates torque vs magnetization current for a VAFL, in accordance with one or more embodiments of the invention.

FIG. 7 shows power vs speed for a VAFL and a radial VFMM, in accordance with one or more embodiments of the invention.

### DETAILED DESCRIPTION

This application discloses improvements to U.S. patent application Ser. No. 16/383,274 entitled “A VARIABLE-FLUX MEMORY MOTOR AND METHODS OF CONTROLLING A VARIABLE-FLUX MOTOR” and filed on Apr. 12, 2019, and U.S. patent application Ser. No. 17/431,080 entitled “CURVED MAGNETS FOR A VARIABLE-FLUX MEMORY MOTOR” and filed on Aug. 13, 2021, which are incorporated by reference in their entireties.

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it would have been apparent to one of ordinary skill in the art that the invention may be practiced without these specific details. In other instances, well-known features have not been described in detail to avoid unnecessarily complicating the description.

Variable flux memory motors (VFMM) have been researched and developed in various forms in academia and industry. Examples of a VFMM are discussed in U.S. Pat. No. 10,848,014, titled “A VARIABLE-FLUX MEMORY MOTOR AND METHODS OF CONTROLLING A VARIABLE-FLUX MOTOR,” and in U.S. patent application Ser. No. 17/237,585, titled “FLUX-MNEMONIC PERMANENT MAGNET SYNCHRONOUS MACHINE AND MAGNETIZING A FLUX-MNEMONIC PERMANENT MAGNET SYNCHRONOUS MACHINE,” the content of which are incorporated by reference in their entirety.

One or more embodiments of the invention are directed to increasing the torque density of a VFMM by designing the VFMM as a variable axial flux motor (VAFL). Axial flux motors have been utilized in research and industrial applications such as wind turbines and electric vehicles. Axial flux motors are generally used for high torque applications because of their considerable higher amount of torque density compared to radial flux motors. Although axial flux motors have some complexity in manufacturing, their performance has caused the industry to embrace these types of motors.

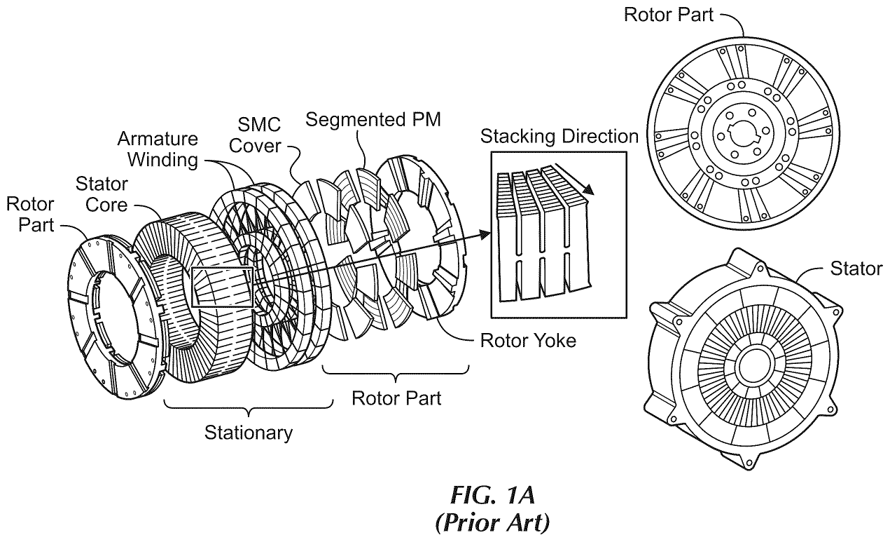

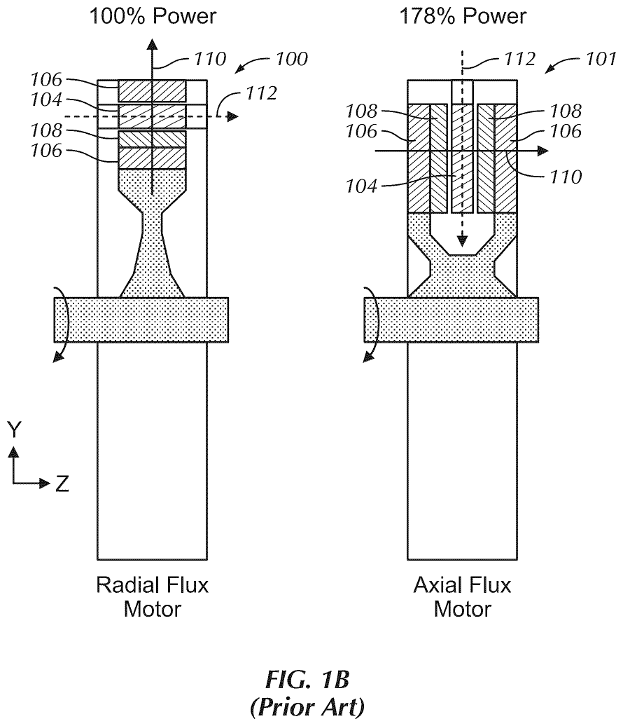

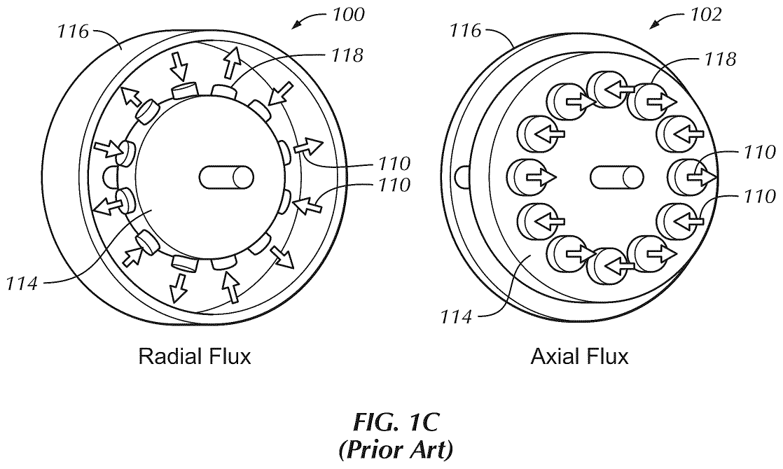

Axial flux motors are mainly designed to have either a single stator and two rotor parts or two stator parts and a single rotor. FIG. 1A shows an axial flux motor that includes a single stator and two rotor parts. In FIG. 1A, the stator is between the two rotor parts along the rotational axis of the motor. The rotor parts of the axial flux motor in FIG. 1A use permanent magnets (PM).

FIG. 1B illustrates cross-sectional views of a radial flux motor (100) and of an axial flux motor (101). In the radial flux motor (100), the coils (104), magnetic circuit (106), and permanent magnets (108) are aligned along a radial direction of the motor (Y axis). As a result, in the radial flux motor (100), the magnetic flux (110) is along the radial direction, and the current (112) is along the rotational axis of the motor (Z axis). On the other hand, in the axial flux motor (101), the coils (104), magnetic circuit (106), and permanent magnets (108) are aligned along the rotational axis of the motor (Z axis). As a result, in the axial flux motor (101), the magnetic flux (110) is along the rotational axis of the motor, and the current (112) is in the radial direction of the motor (Y axis).

The axial flux motor (101) may have a larger amount of axial surface area, that can have better energy conversion, compared to the radial flux motor (100). In the radial flux motor (100), energy conversion takes place in a cylindrical air gap between the rotor and stator. For example, as shown in FIG. 1C, in the pole (118) of the radial flux motor (100), the magnetic flux (110) is fed from the stator (116) to the rotor (114) in the radial direction. As a result, in the radial flux motor (100), power may scale up with the square of the motor diameter.

On the other hand, in the axial flux motor (101), energy conversion takes place in a larger area between the rotor and stator. For example, as shown in FIG. 1C, in the axial flux motor (101), the magnetic flux (110) is fed from the stator (116) to the rotor (114) in a direction along the rotational axis of the motor. As a result, power may scale up at a rate somewhere between the second and third power of motor diameter thanks to the larger energy conversion area of the axial flux motor (101). Accordingly, the axial flux motor (101) may produce more power than the radial flux motor (100) having a similar motor diameter. For example, as shown in FIG. 1B, the axial flux motor (101) may have 78% higher power than the radial flux motor (100) having a similar size.

The conventional axial flux motors shown in FIGS. 1A-C include only permanent magnets in the rotor to interact with the magnetic field of the stator, and they do not have soft magnets (made of a soft-ferromagnetic material). Accordingly, the revolutions per minute (RPM) speed of the axial flux motors, which have only permanent magnets, may be fixed to limiting factors such as number of poles, available voltage, and flux linkage (lambda or λₘ), which is provided and is fixed by the permanent magnets. Permanent magnet, hard magnet, high coercive force (HCF) magnet, and rare-earth magnet refer to each other and may be used interchangeably.

Because the flux linkage provided by the permanent magnet is fixed in the conventional axial flux motors using only permanent magnets, the axial flux motors have a narrow constant power speed ratio (CPSR). CPSR is the speed range at which the drive of the motor can maintain a constant power with limited values of input voltage and current of the motor. Thus, increasing the CPSR of the axial flux motors without using advanced control techniques, such as implementing flux-weakening control methods, may be difficult. Because of the narrow range of CPSR for the axial flux motors, using a transmission system may be required to change the CPSR of a system driven by the motors. Even using such advanced methods may extend the CPSR of the axial flux motors to only 2 to 3.

In general, embodiments of the invention relate to designs of VFMMs that include soft magnets. More specifically, embodiments of the invention relate to designs of variable axial flux motors (VAFL), which are a type of VFMMs, that include soft magnets. The intended soft magnets have high permeability (same as hard magnets) but low coercivity (unlike hard magnets). Because of the low coercivity of soft magnets, changing the magnetization of soft magnets requires relatively smaller magnetic field compared to hard magnets. For example, changing magnetization of soft magnets such as aluminum nickel cobalt (AlNiCo) may require less than one-tenth of the power required for magnetization of some grades of neodymium iron boron (NdFeB). Accordingly, magnetization of magnets of the VAFL (hereinafter, will be referred to as “VAFL magnetization” for simplicity) can be adjusted (i.e., changed) during operation or assembly of the VAFL. The adjustment of the VAFL magnetization may change the RPM of the VAFL. According to one or more embodiments, the soft magnets of the VAFL may be made of AlNiCo or some types of ceramics. Soft magnet and low coercive force (LCF) magnet refer to each other and can be used interchangeably.

According to one or more embodiments, the soft magnets may be AlNiCo with grades 1-9 or magnets comprised of AlNiCo, cast, ceramics, some grades of samarium cobalt, or sintered construction of these materials. It is apparent that one of ordinary skill in the art could use specific amounts of these materials to achieve a desired function of the VAFL.

The VAFL in accordance with one or more embodiments may be an improved substitute to the conventional axial flux motors, where only hard magnets are used, because high RPMs may be more efficiently attained, at limited voltages, through changing the VAFL magnetization. The overall magnetization of the soft magnets can be changed to any value from 0% magnetization (i.e., the soft magnets are completely demagnetized) to 100% magnetization (i.e., the soft magnets are magnetized to their maximum capacity in a short time (e.g., about 1 millisecond). Accordingly, the CPSR of the VAFL could have a wider range compared to the CPSR of the conventional axial flux motor. For example, the CPSR of the VAFL according to one or more embodiments may achieve 4 to 6. Thus, there is no need to couple a transmission system to the VAFL. Consequently, the design of VAFL in accordance with one or more embodiments may reduce manufacturing costs of electric motor-equipped systems due to being magnetized or demagnetized during operation or assembly.

Additionally, according to one or more embodiments, because hard magnets are made of rare-earth-materials, they are significantly more expensive than soft magnets (e.g., AlNiCo). Accordingly, even partially using soft magnets in the VAFL may significantly reduce manufacturing costs of the VAFL compared to conventional axial flux motors.

In one or more embodiments, a certain number or amount of hard magnets may be used to create a magnetization baseline in the VAFL. Because the magnetization of the hard magnets is reluctant to change, the magnetization of the hard magnets may be the magnetization baseline, and the magnetization of the soft magnets may change the overall magnetization from the magnetization baseline (to higher or lower magnetization from the baseline, depending on the torque and RPM of the VAFL).

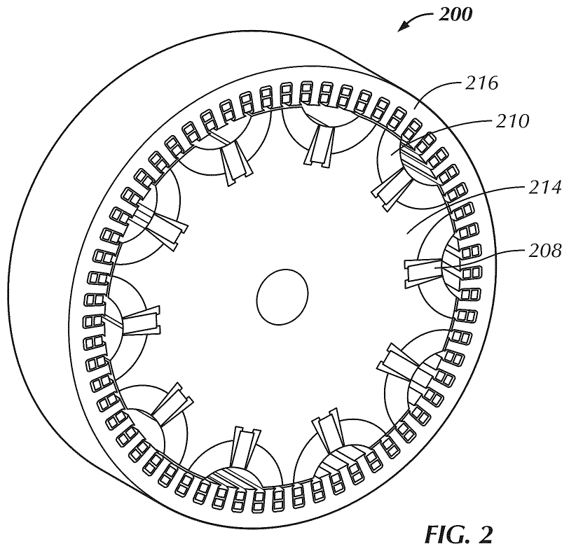

FIG. 2 shows a radial VFMM (200) that includes a rotor (214) and a stator (216). The rotor (214) may include permanent magnets (208) and soft magnets (210) that together may configure a horseshoe shape. The horseshoe shape of the permanent magnets (208) and soft magnets (210) may increase torque and power densities of the radial VFMM (200).

Because the radial VFMM (200) uses soft magnets (210) for magnetization, one concern may still be insufficient high torque density of the radial VFMM (200). One or more embodiments of the invention are directed to increasing the torque density of a VFMM by designing the VFMM as VAFL.

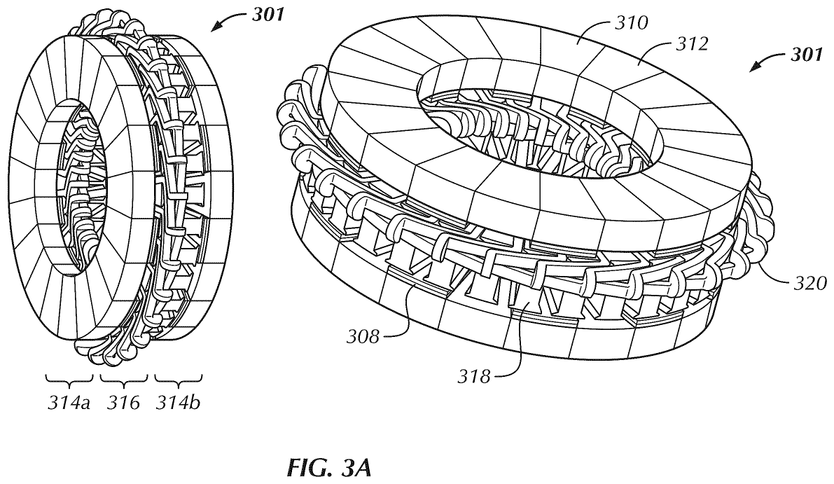

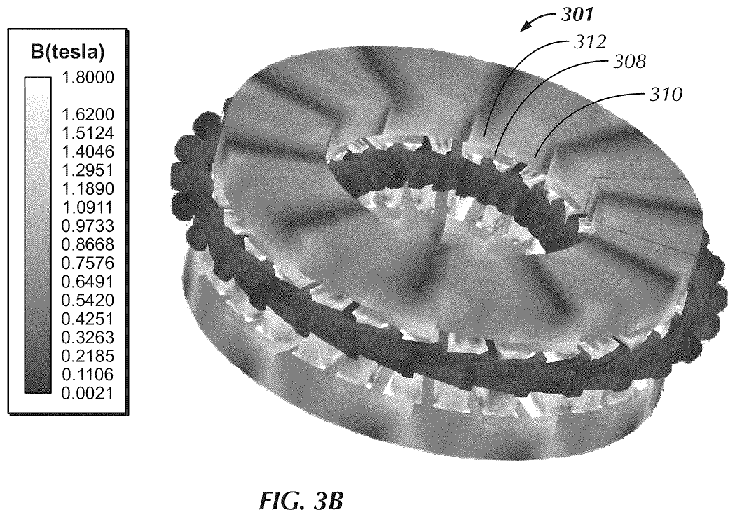

FIG. 3A shows different views of a VAFL (301), according to one or more embodiments of the invention. The VAFL (301) includes a stator (316) and a rotor that may include a first rotor part (314a) and a second rotor part (314b). The stator (316) may be in between the first rotor part (314a) and the second rotor part (314b) in a direction along the rotational axis of the VAFL. The stator (316) may include stator teeth (318) that may be wrapped with three-phase windings (320). To simplify illustration, the windings (320) are concentrated, and can have different number of throws depending on a specific design and function of the VAFL. The stator core and the stator teeth (318) may be made of a ferrous material such as M15 or nonlaminated ferrous materials.

The first rotor part (314a) may include hard magnets (308), soft magnets (310), and ferrous parts (312). The ferrous parts (312) may be considered as the core of the rotor. The ferrous part (312) may be made of a magnetically permeable material such as cobalt or silicon steels, and the soft magnet (310) may be a grade AlNiCo. The second rotor part (314b) may include similar elements as the first rotor part (314a). The second rotor part (314b) may be symmetrical of the first rotor part (314a) with respect to the stator (316).

In one or more embodiments, the thickness of the hard magnet (308) along the rotational axis may be less than the thickness of the ferrous part (312) and/or the thickness of the soft magnet (310) along the rotational axis. For example, the thickness of the hard magnet (308) may be equal to or less than 30% of the total magnet thickness, and the thickness of the soft magnet (310) may be equal to or more than 70% of the total magnet thickness. In FIG. 3A, the total magnet thickness is the sum of the thickness of the hard magnet (308) and the thickness of the soft magnet (310). The thickness of the soft magnet (310) may be the same as the thickness of the ferrous part (312), along the rotational axis. In another example, the thickness of the hard magnet (308) may be equal to or less than 20% of the total magnet thickness, and the thickness of the soft magnet (310) may be equal to or more than 80% of the total magnet thickness. In FIG. 3A, the thickness of the hard magnet (308) is equal to 20% of the total magnet thickness, and the thickness of the soft magnet (310) is equal to 80% of the total magnet thickness.

As shown in FIG. 3A, the radial length (i.e., along the radius of the rotor) of the soft magnet (310) may be the same as the radial length of the ferrous part (312). The circumferential width (i.e., along the circumference of the rotor) of the soft magnet (310) may or may not be the same as the circumferential width of the ferrous part (312). The circumferential width of the hard magnet can be, at most, the same as the width of the ferrous part, but it may be smaller too.

FIG. 3B shows magnetic field density for the VAFL shown in FIG. 3A. According to FIG. 3B, in the hard magnet (308), soft magnet (310), and ferrous part, the magnetic coupling between the stator and rotor is strong.

According to one or more embodiments, the VAFL may have higher performance that a radial VFMM having the same dimensions. Table 1 shows higher torque, voltage, and efficiency for the VAFL shown in FIG. 3A with respect to the radial VFMM shown in FIG. 2, considering the same dimensions for the VAFL and radial VFMM.

| | Torque | Voltage | Efficiency |
|---|---|---|---|
| | (Nm) @ 4000 rpm | (VLL) | (%) |
| VAFL | 1198 | 460 | 96.65 |
| Radial VFMM | 805 | 550 | 95.4 |

A radial VFMM may operate as a field weakening machine to partially overcome low torque density issues at high RPMs. Accordingly, the radial VFMM may operate at high voltage and with high power, which may be troublesome. The required voltage at high RPMs for the radial VFMM may be more than the voltage required at nominal RPM of the radial VFMM. On the other hand, the VAFL according to one or more embodiments of the invention may work as a field weakening machine at high RPMs. Unlike the radial VFMM, because of the field weakening at high RPMs in the VAFL, the VAFL may not require a significantly higher voltage and power at higher RPMs than the nominal RPM. In other words, the voltage and power for the radial VFMM at high RPMs may not be as significant as for the VAFL.

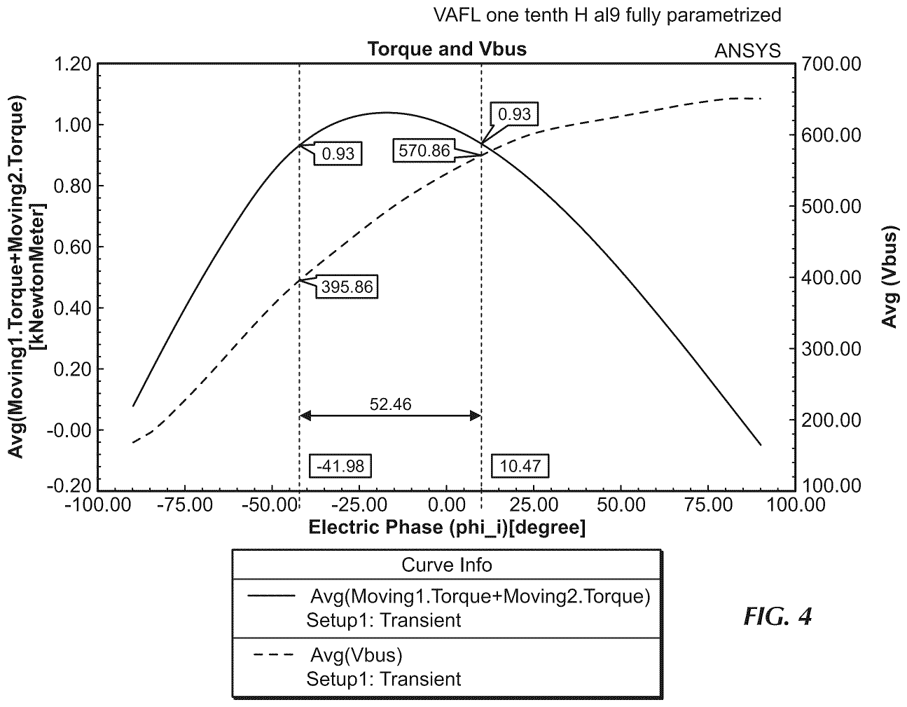

According to one or more embodiments, the torque density of the VAFL may stay high, even after field weakening, due to axial flux passing between the rotor and stator. FIG. 4 shows that to generate 930 Newton meter (Nm) torque, one option may be using the electric phase (phi_i) (i.e., current angle) at 10 degrees, which requires voltage of 570 V, and another option may be using phi_i at −41 degrees, which requires voltage of 395 V. Accordingly, with ˜35% lower voltage (395 V vs 570 V) the same high torque density may be achieved. Being able to use a lower voltage to gain a high torque density for the VAFL, may help in keeping the power constant (or not exceedingly high) for high RPMs, as compared with the radial VFMM.

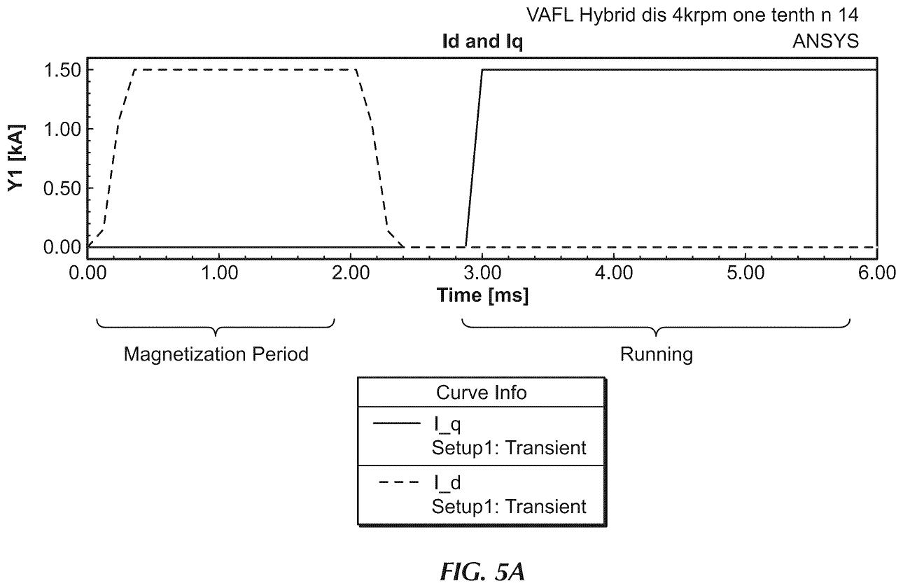

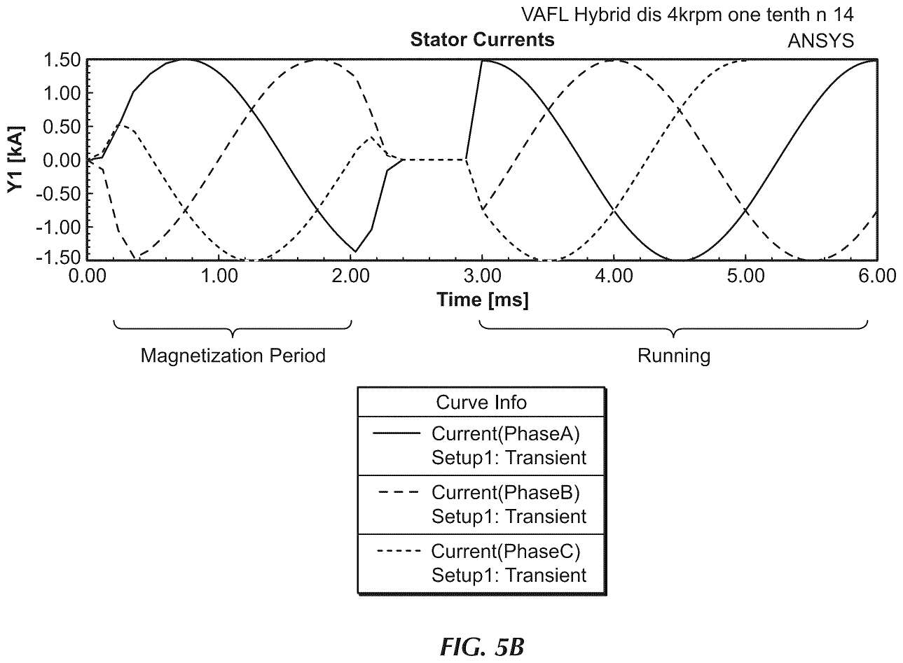

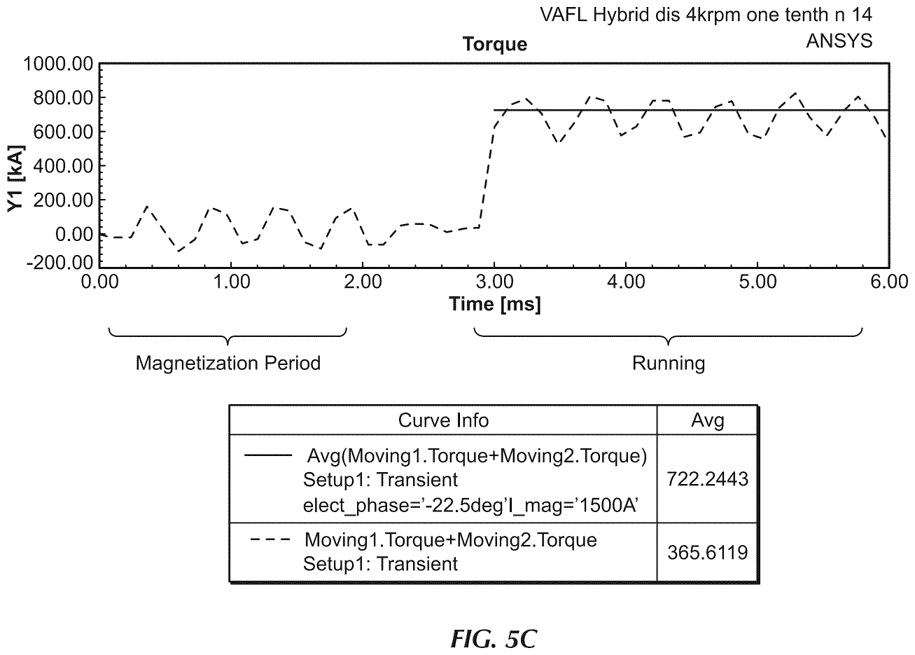

According to one or more embodiments, the process of magnetization and running the VAFL may be similar to a radial VFMM in such a way that the magnetization and running may happen in consecutive order or simultaneously. FIGS. 5A-5C show procedures for applying currents in a magnetization period and, as a result, producing torque in a running period in a VAFL. As shown in FIG. 5A, the VAFL may become magnetized for about 2 milliseconds (ms) using direct axis current (Id) pulse. Then, the quadrature axis current (Iq), with or without +/−Id, is applied for running torque. FIG. 5B shows the currents in the stator windings, which correspond to Id and Iq in FIG. 5A. And FIG. 5C shows the generated torque in the VAFL related to FIGS. 5A and 5B.

According to one or more embodiments, because the design of VAFL allows field weakening, two methods may be used for controlling flux linkage. One method may be field weakening through sweeping phi_i. The effect of field weakening through sweeping phi_i on torque and voltage was discussed with respect to FIG. 4, where at phi_i equal to −41 degrees, the voltage required for reaching the high torque of 930 Nm is 395 V, which is lower than the voltage 570 V at phi_i equal to 10 degrees for reaching the same torque.

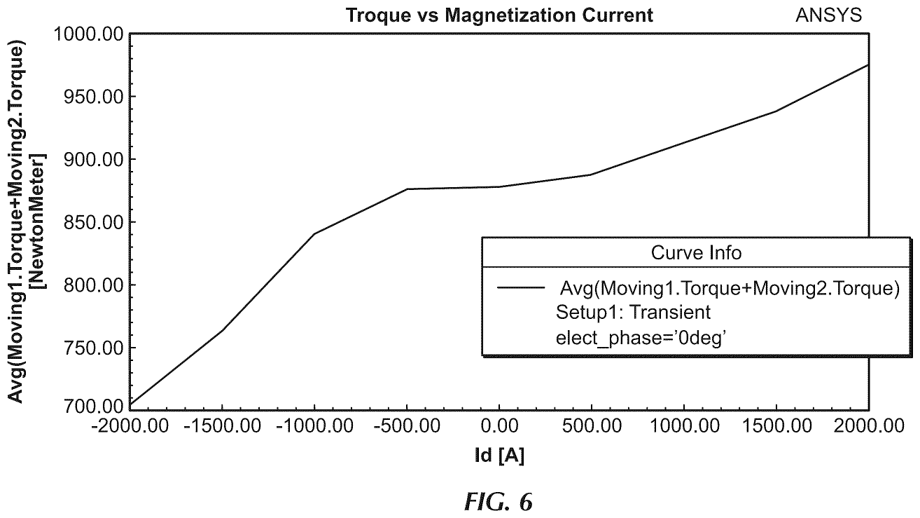

The other method may be pulsating the Id. The effect of pulsating the Id is shown in FIG. 6. Because the VAFL includes soft magnets, by applying the Id pulse, the flux linkage, and accordingly the torque, can be changed. Decreasing the flux linkage can also be done through field weakening by changing phi_i.

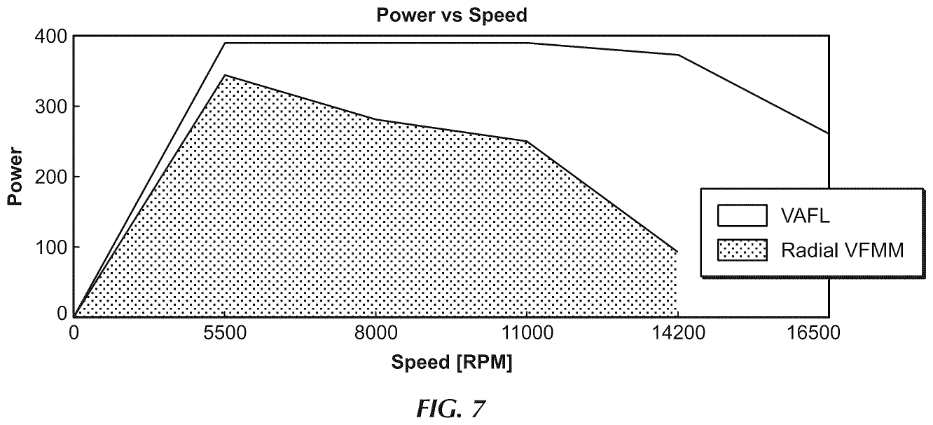

According to one or more embodiments, the VAFL may provide high torque densities at relatively lower voltages, compared to the radial VFMM, for higher RPM ranges. FIG. 7 demonstrates the power-speed (RPM) curves of the VAFL and radial VFMM of the same size (dimensions), and at the same current density and voltage. The VAFL and radial VFMM of FIG. 7 also have the same volume ratio between the soft magnet and the hard magnet. As shown in FIG. 7, the VAFL can maintain more power for high RPMs compared with the radial VFMM. For example, the power of the VAFL at 14,200 RPM, which is around 3 times of the nominal RPM of the VAFL, is more than 100% higher than the power of the radial VFMM.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A variable axial flux motor (VAFL) comprising:
a stator; and
a first rotor part,
wherein the stator is disposed next to the first rotor part, along a rotational axis of the VAFL, and
wherein a pole of the first rotor part comprises:
a first hard magnet;
a first soft magnet; and
a first ferrous part.
